(19) United States
(12) Patent Application Publication
(10) Pub. No.: US 2024/0294158 A1
(43) Pub. Date: Sep. 5, 2024

(54) HYDRAULIC ACTUATING SYSTEM FOR A BRAKING SYSTEM HAVING A 3/2-WAY VALVE FOR SELECTIVE CONNECTION OF THE MAIN BRAKE CYLINDER EITHER TO THE TRAVEL SIMULATOR OR TO AT LEAST ONE BRAKE CIRCUIT

(71) Applicants: Heinz Leiber, Oberriexingen (DE); IPGATE AG, Pfäffikon/Sz (CH)

(72) Inventors: Heinz LEIBER, Oberriexingen (DE); Anton VAN ZANTEN, Ditzingen (DE)

(21) Appl. No.: 18/282,170

(22) PCT Filed: Mar. 15, 2022
(86) PCT No.: PCT/EP2022/056626

§ 371 Date: Sep. 14, 2023

(30) Foreign Application Priority Data
Mar. 15, 2021 (DE) 10 2021 106 270.5

(51) Int. Cl. B60T 13/68; B60T 8/40; B60T 13/16; B60T 13/62; B60T 17/00; F16K 31/06

(52) U.S. Cl. CPC B60T 13/686; B60T 8/4081; B60T 13/161; B60T 13/168; B60T 13/62; B60T 17/00; F16K 31/0637; B60T 2270/402

(57) ABSTRACT

A hydraulic actuation system for a brake system may include at least one brake circuit including at least one wheel brake, a master cylinder that may be actuated using an actuating device and having at least one working chamber, and a hydraulic travel simulator. The working chamber may be connected via a 3/2-way valve either to a brake circuit or to the travel simulator.

The invention relates to a hydraulic actuation system for a braking system with the features of the preamble of claim 1 and a 3/2-way valve correspondingly designed therefor.

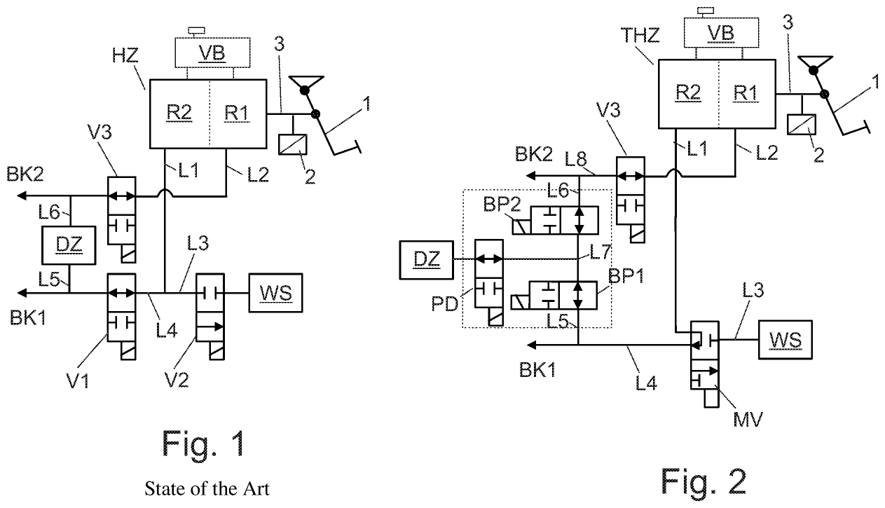

A possible generic brake system is shown in FIG. 1. The brake system has a master brake cylinder HZ, which is designed as a tandem master brake cylinder with two working chambers R1 and R2, whereby the working chamber R1 can be connected to the brake circuit BK2 via the hydraulic line L2 and the connecting valve V3. Working chamber R2 can be connected to brake circuit BK1 via hydraulic lines L1 and L4 and connecting valve V1. The hydraulic line L1 is also connected to the hydraulic line L3, to which a travel simulator WS is connected, whereby the hydraulic line L3 can be shut off by means of the connecting valve V2. In addition, the braking system also has at least one pressure supply device DZ, which is connected to the brake circuits BK1 and BK2 via hydraulic lines L5 and L6, with additional valves, not shown in FIG. 1, generally being provided for shutting off lines L5 and L6. Provided that the brake system operates without malfunctions, which is referred to as normal operation, the two connecting valves V1 and V3 are closed and the connecting valve V2 is open. If the brake pedal 1 is actuated by the person driving the vehicle, the brake pressure in the brake circuits BK1 and BK2 is controlled or adjusted by the at least one pressure supply device DZ as a function of the brake pedal position, which is determined by means of the sensor 2. When the brake pedal 1 is adjusted, a pressure is built up via the plunger 3 and the piston present in the master brake cylinder HZ in cooperation with the travel simulator WS, resulting in a reaction force that gives the person a pedal feel. At least the connecting valve V2 is always designed as a 2/2-way valve. If a malfunction occurs in which pressure control in the brake circuits BK1 and BK2 is no longer possible by means of the at least one pressure supply device DZ, the two connecting valves V1 and V3 are opened and the connecting valve V2 is closed. In this state, also referred to as the fallback state, the master brake cylinder HZ acts as the pressure supply source for the brake circuits BK1 and BK2, and in this state the pressure in the brake circuits can be built up by means of the brake pedal 1. Closing the connecting valve V2 prevents the travel simulator WS from influencing the brake pressure build-up. If the connecting valve V2 were not closed, the volume of the travel simulator WS would act as a loss volume of the master brake cylinder, which would lead to an increase in pedal travel and thus to a lower brake pressure. Due to the lack of brake boosting, very high pedal forces would thus be required with the V2 connecting valve still open, which would far exceed the legal requirements. Due to the lack of brake boosting, the master cylinder HZ is often referred to as an auxiliary circuit.

A disadvantage of the prescribed braking system is that at least three connecting valves and thus a relatively large number of hydraulic lines are required to shut off the master brake cylinder HZ with respect to the brake circuits BK1 and BK2 and the travel simulator WS, which is not only expensive to manufacture but also results in a relatively large construction volume of the hydraulic module in which the valves of the braking system are combined.

3/2-way solenoid valves are widely used in hydraulic drives and especially in automotive braking systems. In braking systems, 2/2-way solenoid valves are mostly used for pressure control and regulation. 3/2-way solenoid valves, on the other hand, are mostly used for switching individual components of the braking system on and off. DE 10 2017 000 472 A1, for example, discloses the use of 3/2-way solenoid valves to connect the brake circuits either to the motor-driven pressure supply device or to the master brake cylinder. However, the use of 3/2-way valves, as known from DE 10 2017 000 472 A1, leads to problems in the event of failure or a leaky valve seat. If, for example, the hydraulic connection from the master brake cylinder to the pressure supply device in the 3/2-way solenoid valve is defective, i.e. leaking, this leads adversely to a strong pedal reaction, which inevitably results in the pressure supply device being switched off, with the braking force boosting being lost at the same time.

The task of the present invention is to further develop the generic braking system in such a way that it requires fewer valves and is thus more cost-effective, smaller and lighter.

This task is solved according to the invention with a hydraulic actuation system having the features according to claim 1. A 3/2-way valve according to the invention for a hydraulic actuating system according to claims 1 to 9 is claimed by claim 11 and the following.

The invention is based on the idea of replacing the two 2/2-way solenoid valves V1 and V2 (see FIG. 1), which have conventionally served to selectively connect one working chamber of the master brake cylinder either to the travel simulator or to the brake circuit, by a single 3/2-way valve. This saves costs and installation space in the so-called hydraulic control unit. In addition, even with a leaky 3/2-way valve, pressure control is still advantageously possible by means of the pressure supply device, while at the same time a pressure in the master brake cylinder for setting a pedal feel can still be adjusted by corresponding control of the 3/2-way valve. This makes the braking system according to the invention advantageously much more fail-safe than conventional braking systems.

In the hydraulic actuation system for a brake system according to the invention, the one working chamber of the master brake cylinder can be connected via the controlled 3/2-way valve either to a brake circuit or to the travel simulator. In addition, the brake system has at least one pressure-generating device for pressure control or regulation, in particular for pressure build-up and/or pressure reduction, in the at least one brake circuit. Of course, it is also in the spirit of the invention if the braking system additionally has at least one exhaust valve for pressure reduction and/or an alternative control element, such as a further pressure supply device DZ driven by an electric motor, for pressure reduction.

In so-called “normal operation” of the braking system, pressure control or regulation in the at least one brake circuit takes place by means of the pressure generating device. In this operating state, the working chamber of the master brake cylinder is only hydraulically connected to the travel simulator via the 3/2-way valve. The hydraulic connection from the working chamber to the brake circuit is interrupted. For this purpose, the 3/2-way valve is energized and the solenoid armature takes a first position, which is also referred to below as the second switching state of the 3/2-way valve, in which it presses a first valve closing body against the associated valve seat and thus closes a first hydraulic connection of the 3/2-way valve, which is used to connect the connections for the brake circuit and the master brake cylinder. The pressure prevailing in the brake circuit thereby acts in support of the magnetic force on the first valve closing body. To make this possible, according to the invention the 3/2-way valve is arranged in the hydraulic connection between the pressure supply device and the master brake cylinder. The valve spring in the 3/2-way valve can thus be dimensioned with increased restoring force, so that the 3/2-way valve advantageously still switches reliably from the first position of the solenoid armature to the second position of the solenoid armature in the second switching state of the 3/2-way valve even when the pressure in the brake circuit is greater than 150 bar, i.e. beyond the pressure during fading. This advantageously increases the reliability of the braking system.

A diagnosis to determine the failure of the valve spring can advantageously be made simply via the switching current of the solenoid valve.

If the 3/2-way valve leaks, the brake system can advantageously continue to be operated with the pressure supply device for pressure control in the wheel brakes or brake circuits. By controlling the 3/2-way valve accordingly, a pedal characteristic that can still be accepted by the person driving can be adjusted. For this purpose, the pressure in the working chamber of the master brake cylinder can advantageously be adjusted by appropriate switching of the 3/2-way valve between its two switching states in order to regulate a specific pedal characteristic, the pressure generated by the pressure supply device being used for this purpose. In this way, even in the event of failure of the travel simulator and/or leakage of the 3/2-way valve, in particular of the hydraulic connection between the connections for the travel simulator and the master brake cylinder, braking force boosting can still be maintained by means of the at least one pressure supply device.

Advantageously, many components of conventional 2/2-way valves, such as those used for the anti-lock braking function (ABS), can be used for the 3/2-way valve according to the invention. In particular, the electromagnetic part of a conventional 2/2-way valve can be used for the 3/2-way valve according to the invention. The additionally required second valve seat with second valve closing body and valve spring can be combined in a separate unit. The first valve closing body is arranged in a first valve chamber and the second valve closing body in a second valve chamber. A third valve chamber is arranged between the two valve seats. The first valve chamber is connected via a channel to a first valve connection for the brake circuit and the second valve chamber is connected via a channel to a second valve connection for the travel simulator. The third valve chamber is connected via a channel to the valve connection for the master cylinder. The first valve closing body is advantageously connected to the solenoid armature, with a plunger being arranged on the first valve closing body, which engages through both valve seats and is dimensioned in its length such that, in the first switching state of the solenoid valve, the second valve closing body is lifted off the second valve seat by the plunger against the valve spring force, so that the hydraulic connection between the second and third valve ports is opened. In the second valve position, when the 3/2-way valve is de-energized, the second valve closing body is pressed by the valve spring against the second valve seat in a sealing manner and, in the process, the first valve closing body is lifted from the first valve seat by the plunger, as a result of which the first hydraulic connection between the first and third valve connections is opened and the second hydraulic connection between the third and second valve connections is interrupted.

The diameter of the pin connecting the solenoid armature to the first valve closing body can be made smaller than in standard 2/2-way valves for ABS, which means that approx. 20% solenoid force can be realized. In order to reduce the power loss of the 3/2-way valve for the high forces, the excitation winding of the 3/2-way valve can advantageously be cast into the solenoid housing and this can be provided with a heat sink. It is also possible to arrange a permanent magnet in the yoke to reduce power loss.

Both a single and a tandem master cylinder can be used as the brake master cylinder.

The use of a single master brake cylinder is advantageous in terms of cost reduction and increased safety due to smart redundancy.

Wheel brakes are connected to the brake circuits described above in a known manner via further valve circuits, which are not explained further here.

The following figures illustrate in more detail the braking system according to the invention and the 3/2-way valve required for it.

Figures show:

FIG. 1: conventional braking system with master cylinder, pedal, travel simulator and three 2/2-way valves;

FIG. 2: first possible embodiment of a hydraulic actuation system according to the invention for a brake system with a 3/2-way valve for the selective connection of the master brake cylinder, which is designed as a tandem brake cylinder, with the travel simulator or the brake circuit;

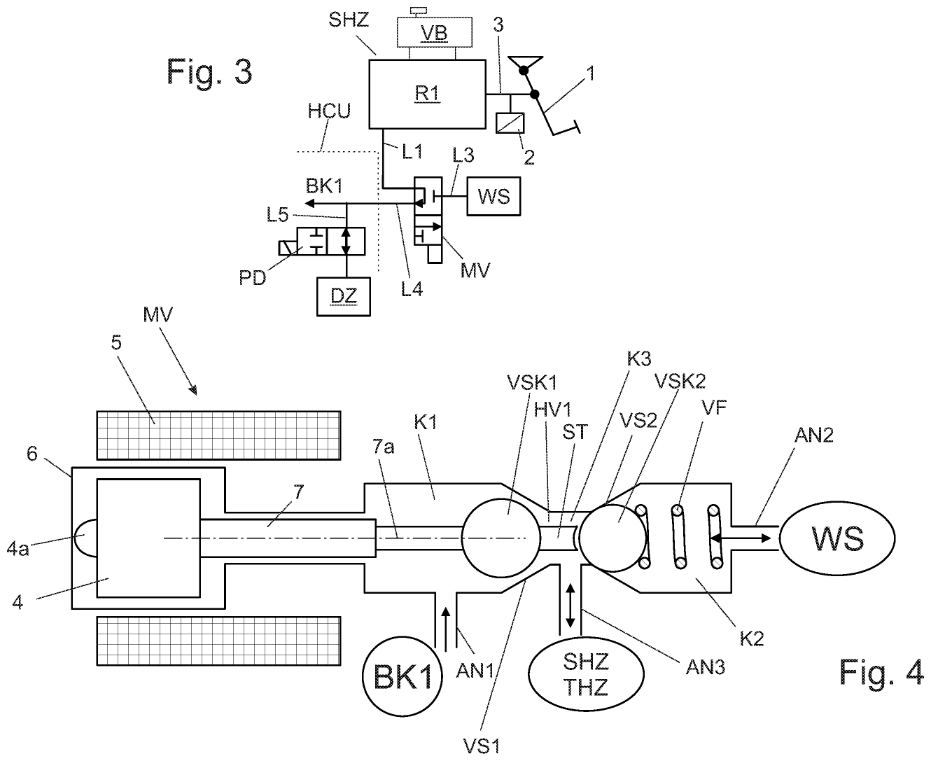

FIG. 3: second possible embodiment of a hydraulic actuation system according to the invention for a brake system with a 3/2-way valve for the selective connection of the master brake cylinder designed as a single brake cylinder with the travel simulator or the brake circuit;

FIG. 4: schematic illustration of a possible embodiment of a 3/2-way valve for the actuation system according to the invention;

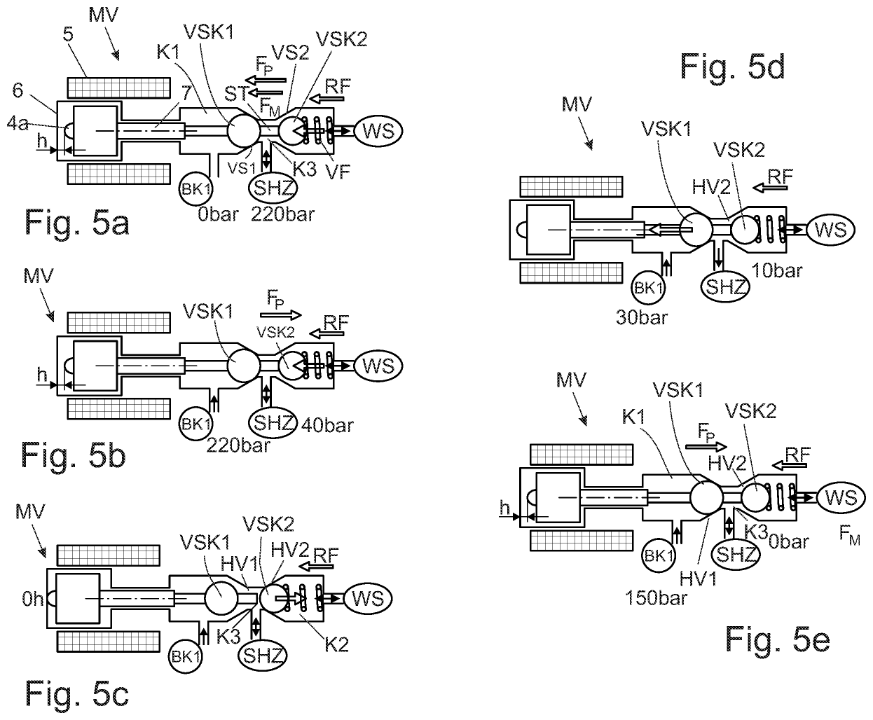

FIG. 5a-5e: different operating states of the hydraulic actuation system according to the invention;

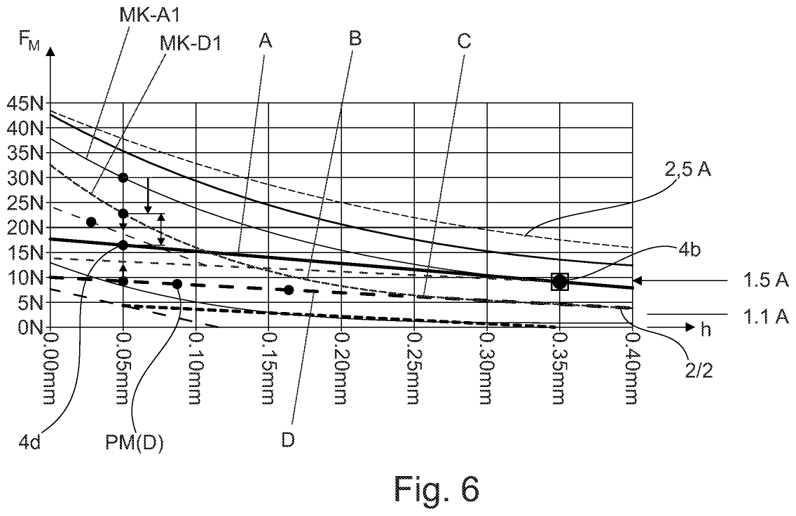

FIG. 6: solenoid map of the 3/2-way valve;

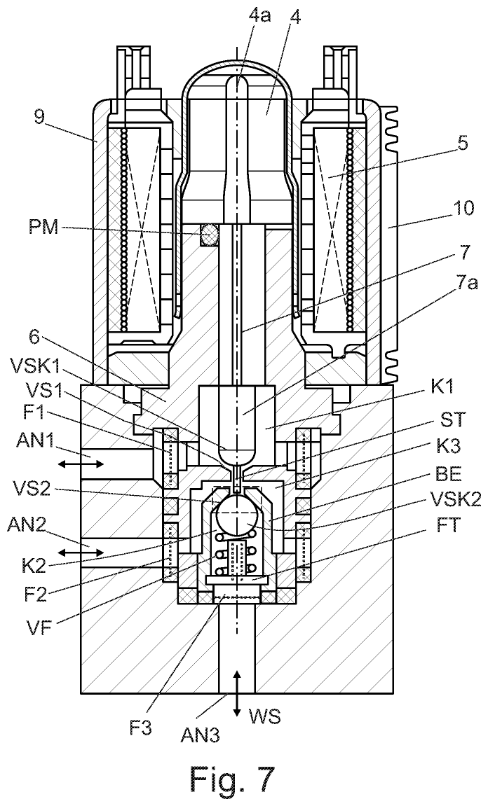

FIG. 7: possible design of a 3/2-way valve;

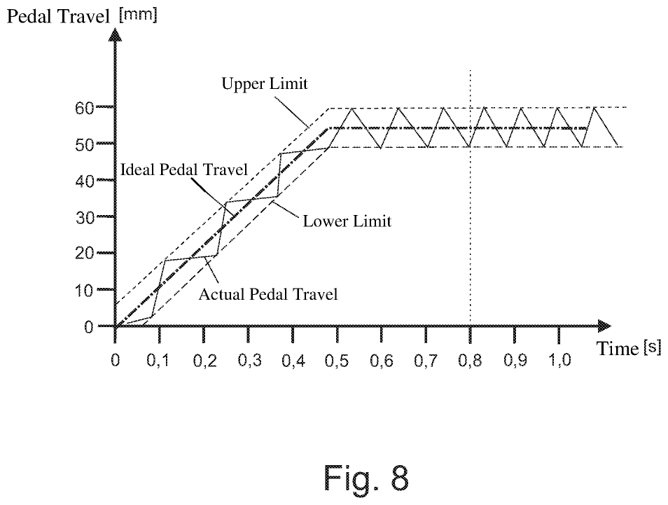

FIG. 8: time course of the pedal travel in the event of malfunction to produce an acceptable pedal feel.

FIG. 2 shows a first possible embodiment of a hydraulic actuation system according to the invention with a 3/2-way valve MV for selective connection of the main brake cylinder THZ, designed as a tandem brake cylinder, to the travel simulator WS or the first brake circuit BK1. The tandem brake master cylinder (THZ) has a reservoir VB and two working chambers R1 and R2. The piston separating the two working chambers R1 and R2, which can be adjusted via pin 3 by means of pedal 1, is not shown. The first working chamber R1 is connected by means of the hydraulic line L2 to the connecting valve V3, which optionally separates the hydraulic line L2 from the brake circuit line L8 of the 2nd brake circuit BK2 or connects it to the latter. The 2nd working chamber R2 of the tandem master brake cylinder THZ is connected to the 3/2-way valve MV by means of the hydraulic line L1. Depending on the switching state of the 3/2-way valve MV, the hydraulic line L1 is connected to the hydraulic line L3 to the travel simulator WS or to the hydraulic line L4 of the first brake circuit BK1. FIG. 2 shows the 3/2-way valve MV in the de-energized state, which corresponds to the second switching state of the 3/2-way valve MV described above. The dashed box shows an example of the 3 valves PD BP1 and BP2, which are used to connect the pressure supply device DZ to the two brake circuits BK1 and BK2. Of course, it is also possible to use a second pressure supply device (not shown) with a correspondingly adapted valve circuit.

FIG. 3 shows a further second possible embodiment of a hydraulic actuation system for a brake system according to the invention, in which, in contrast to the brake system according to FIG. 2, the master brake cylinder is designed as a single master brake cylinder with only one working chamber R1. The working chamber R1 of the single master brake cylinder SHZ is connected via the hydraulic line L1 to the 3/2-way valve MV, which, analogous to the 3/2-way valve MV shown and described in FIG. 2, connects the working chamber R1 optionally to the travel simulator WS or the brake circuit BK1. In this type of braking system, the pressure supply device can be connected to the brake circuit BK1 via a separating valve PD with a hydraulic line L5.

FIG. 4 shows a schematic illustration of a possible embodiment form of a 3/2-way valve MV for the braking system according to the invention. The 3/2-way valve MV has an exciter winding 5 arranged around a solenoid yoke 6, in which the solenoid armature 4 is adjustable in axial direction to the pin 7, 7a. A stop element 4a is arranged at the left end of the magnet armature 4, which abuts against the inner wall of the magnet yoke 6 in the non-energized second switching state of the valve MV shown in FIG. 4. The first valve closing body VSK1 is arranged at the right-hand end of the connecting bolt 7, 7a and is firmly connected to the connecting bolt end 7a. The first valve closing body VSK1 acts together with the first valve seat VS1, which can be part of the solenoid yoke 6. In the area of the pin section 7a, the solenoid yoke 6 forms a first valve chamber K1, which is connected via a hydraulic channel to the first valve connection AN1 for the connection of the brake circuit BK1.

The 3/2-way valve MV also has a second valve chamber K2 in which the valve spring VF and a second valve closing body VSK2 are arranged. The second valve chamber K2 is connected via a hydraulic channel to the second valve connection AN2, to which the travel simulator WS is connected. The second valve chamber K2 forms with its left side the second valve seat VS2 of the valve MV, which cooperates with the second valve closing body VSK2. A third valve chamber K3 is arranged between the two valve seats VS1 and VS2 and is connected to the third valve connection AN3 for the master cylinder SHZ or THZ. On the side of the first valve closing body VSK1 facing away from the pin 7, 7a, a plunger ST is formed or fastened, the length of which is dimensioned such that it reaches through the first valve seat VS1 and the third valve chamber K3 and can act with its free end on the second valve closing body VSK2 in the energized state of the 3/2-way valve MV. FIG. 4 shows the “de-energized” state. In this state, the valve spring VF presses the second valve closing body VSK2 against the second valve seat VS2, whereby the solenoid armature 4 is also moved to the left so that the first hydraulic connection HV1 between the first valve chamber K1 and the third valve chamber K3 is open, whereby the master brake cylinder SHZ or THZ is connected to the first brake circuit BK1 and the travel simulator WS is disconnected from the third valve chamber K3.

The dimensions of the valve spring VF determine the opening pressure in the fallback state, e.g. in the event of failure of the pressure supply device DZ. Here, the legislator requires that a vehicle deceleration of 0.24 g can be generated with a foot force on brake pedal 1 of 500N. By dimensioning the valve spring to 75 bar opening pressure in the master brake cylinder, almost 3 times the deceleration value can be achieved.

FIGS. 5a to 5e show various operating states of the braking system according to the invention and are explained individually in more detail below.

FIG. 5a shows a first limiting case in which the solenoid valve MV is energized and is in the first switching state, in which the master brake cylinder SHZ is connected to the travel simulator WS. A pressure of 0 bar prevails in the brake circuit BK1, and a pressure of 220 bar is generated by means of the master brake cylinder SHZ. This causes the valve spring force R_{F}, the solenoid force F_{M} as well as the force F_{P} caused by the hydraulic pressure to act, whereby the solenoid force F_{M} must be greater than the sum of the forces R_{F}and F_{P} so that the first valve closing body VSK1 remains securely pressed against the first valve seat VS1 in a sealing manner. In this state, the solenoid armature 4 has performed a stroke h from its initial position.

FIG. 5b shows a further limiting case in which a pressure of 220 bar prevails in brake circuit BK1. A pressure of only 40 bar is built up by means of the master brake cylinder SHZ. The force F_{P} acting on the first valve closing body VSK1 due to the differential pressure is considerably greater than the force RF of the valve spring, so that in this state the exciter winding 5 does not have to be energized to hold the solenoid valve MV in this switching state.

FIG. 5c shows the first switching state for the fallback state, in which no pressure control is possible in the brake circuit by means of the pressure supply device. In this operating state, pressure is only built up via the master brake cylinder SHZ by means of the brake pedal. In the normal case, a pressure of greater than 100 bar is built up in the brake circuit BK1 at a pedal force of 200N, resulting in a deceleration of the vehicle of approx. 1 g. At the pressure generated by the master cylinder, the valve spring force RF still causes the second hydraulic connection HV2 between the second and third valve chambers K2 and K3 to close securely. In the fallback state, the law requires that a braking deceleration of 0.24 g is generated at a pedal force of 500N, which not all drivers can apply. For this reason, the valve spring is designed in such a way that at a pedal force of greater than 750 N, the pressure in the third valve chamber K3 becomes so great that the second valve closing body VSK2 is lifted off the second valve seat VS2 against the valve spring force RF, thus opening the hydraulic connection HV2, which means that no pressure increase is possible even at greater pedal force.

FIG. 5d shows the solenoid valve MV in the second switching state under a load that occurs in approx. 70% of all braking operations, with a pressure of 30 bar prevailing in the brake circuit BK1 and a pressure of 10 bar being built up in the master brake cylinder SHZ by means of the brake pedal. Due to the prevailing differential pressure between the valve chambers K1 and K3, the current flow can be considerably lower than in the state shown in FIG. 5a.

FIG. 5e shows an operating state in the event of failure of the electrical control unit (ECU) or electrical actuation during braking with high pressure in brake circuit BK1. Due to the progressive spring force RF of the valve spring VF, it is still able to close the hydraulic connection HV2 and open the first hydraulic connection between the third valve chamber K3 and the first valve chamber K1 even at a pressure of 150 bar in the brake circuit BK1 (valve spring design A).

A decrease in the valve spring force RF can be diagnosed, for example, by the opening current required for the excitation winding 5 to switch the solenoid valve MV to the second switching state in which the first hydraulic connection HV1 is closed.

FIG. 6 shows the magnetic map of the 3/2-way valve MV with current i and magnetic force as a function of the stroke h of the solenoid armature 4. 4b and 4d indicate the operating points for the two main functions, where the operating point 4b corresponds to the state shown and described in FIG. 5c and the operating point 4d corresponds to the state shown and described in FIG. 5e. A is the course of the spring force as it results from the design of the valve spring in the favored design A described above.

B is the force characteristic that results when a second valve spring D is provided, which only acts at a small stroke h. A force curve C is obtained when a permanent magnet PM (see FIG. 7) is used, which applies the necessary opening force at a small stroke h (state according to FIG. 5e). All these solutions are aimed at reducing power loss and heat load. The solenoid curves are also assigned the currents, with e.g. max. 2.5 A. The curve or force balance for the operating point 4b is reached at a current of e.g. 1.5 A. In contrast, a current of 1.0 A is sufficient to reach the operating point 4d.

FIG. 7 shows a possible design of the 3/2-way valve. The upper part, consisting of solenoid armature 4, excitation coil 5, and solenoid yoke 6, corresponds to the design of a standard 2/2-way inlet valve for an anti-lock braking system (ABS). For this reason, no detailed description is given here and only the lower part, which converts the 2/2-way valve into a 3/2-way valve, is described in detail.

The solenoid yoke 6 serves as a guide for the pin 7, 7a, which is connected to the first valve closing body VSK1. Compared to the standard design of the 2/2-way inlet valve, the pin 7 can be made smaller in diameter, which enlarges the effective pole area. This also allows the installation of a permanent magnet PM in the yoke 6 for force assistance of the return spring VF, as described in FIG. 6, in order to achieve smaller power losses. The first valve closing body VSK1 acts together with the first valve seat VS1 and is hemispherical in shape to achieve or ensure a secure sealing effect. The first valve seat VS1 is arranged in the magnet yoke 6. However, the first valve seat VS1 can also be integrated in the magnet yoke 6 or implemented via a flanged plate. A plunger ST is formed on the first valve closing body VSK1 or else connected to the bolt 7a. The plunger engages through the first valve seat VS1 and acts on the second valve closing body VSK2, which is formed as a ball and cooperates with the second valve seat VS2.

As shown, the 2nd valve seat VS2 can be combined with the ball VSK2 and the valve spring VF in a separate housing as a construction unit. This offers advantages in pre-assembly and valve adjustment. For this purpose, the assembly unit is pressed into the yoke housing. To measure the plunger stroke, the ball stop has a hole to record the path of the ball via a measuring pin. For a safe connection of the assembly unit with the magnet yoke, a supply is recommended. To protect the valve seats VS1 and VS2, all connections to the brake circuit, master cylinder and travel simulator are protected with F1, F2 and F3 filters.

The valve is adjusted in such a way that the plunger ST has a small distance to the ball VSK2.

To reduce coil heating, the exciter winding 5 can be potted with the solenoid housing 9. In addition, a ribbed heat sink 10 can be provided.

FIG. 8 shows a time course of the pedal travel in the case of a fault to produce an acceptable pedal feel.

A first possible error can be caused by a leakage of the 3/2 solenoid valve. When the 3/2-way valve is actuated, for example, there may be a leak in the hydraulic connection between the brake master cylinder and the brake circuit due to dirt particles that have penetrated. In this case, the braking system according to the invention can be used to form a fall-back state in which the preservation of the brake pedal characteristic or pe-dal feel is generated by brake pedal travel blending with the pressure supply device DZ.

Normally, during braking by the driver, the pressure in the brake circuit is controlled to the set pressure of the wheel cylinders, which is derived from the brake pedal travel, using the pressure supply device DZ. During braking by the driver (no recuperation), brake fluid flows from the brake circuit, BK1, via the leaky 3/2-way valve into the master brake cylinder SHZ or THZ due to a fault, as a result of which the brake pedal is pressed back and the brake pedal travel is reduced.

In an intact brake system, each brake pedal stroke is associated with a defined pressure in the master brake cylinder SHZ or THZ, which determines the pedal characteristics. The pressure in the master cylinder is measured, e.g. directly with a pressure sensor (not shown), or indirectly with a force-displacement sensor (not shown) which can measure the pedal force, for example. In this way, a target brake pedal travel can be determined for each brake pressure in the master cylinder. The design of the pedal characteristic is such that the pressure in the brake circuit is greater than the pressure in the master brake cylinder.

The error is detected by permanently comparing the actual brake pedal travel with the target brake pedal travel. In the fallback state, if the difference between actual brake pedal travel, which is measured, and target brake pedal travel, FIG. 2, reference sign 2, falls below a selectable lower limit, the pressure supply device DZ is stopped and the valves to the wheel cylinders (not shown) are closed. The control of the 3/2-way valve MV is switched off and an exhaust valve (not shown) in the brake circuit is opened. As a result, brake fluid flows from the master brake cylinder HZ, through the opened connection from the master brake cylinder to the brake circuit, into the brake circuit, and through the exhaust valve into the reservoir, causing the brake pedal travel to increase again. When the difference between the actual brake pedal travel and the set brake pedal travel exceeds a selectable upper limit, the outlet valve, which is not shown, is closed again and the 3/2-way valve is activated again, the pressure supply device DZ is switched on again, the switching valves to the wheel cylinders are opened again and the pressure in the wheel cylinders is set to the set pressure again by the pressure supply device DZ. As a result of the error, the brake pedal travel is reduced again, as already described. When the difference between the actual brake pedal travel and the set brake pedal travel again falls below a selectable lower limit value, the pressure supply device DZ is stopped again, the switching valves to the wheel cylinders are closed, the exhaust valve in the brake circuit is opened, and the control of the 3/2-way valve MV is switched off, thus repeating the process. The brake pedal feel remains largely normal as a result. However, slight vibrations of the brake pedal may occur.

In the following, a possible calculation example for the fallback level, based on average values from FIG. 8, is briefly explained:

The pressure P_{auf} in the wheel cylinders is increased to 100 bar by brake pedal actuation.

At the brake pressure of 100 bar the pedal travel is e.g. 54 mm. Due to the brake pedal travel blending, the amplitude of the pedal vibration should not exceed 5 mm. With a pedal ratio of 4.0, this means a main brake cylinder piston amplitude of 0.125 cm.

At 100 bar pressure in the brake circuit, the master cylinder pressure should be approx. 20 bar. The pressure difference between the master cylinder and the brake circuit is then 80 bar. On average, the pressure difference from the start of braking is 80/2=40 bar. At 40 bar pressure difference across the 3/2 valve, the leakage flow through the valve leakage is e.g. 7 cm³/s.

With a master cylinder piston area of e.g. 2.85 cm², the master cylinder piston is pushed back by the leakage flow at a speed of 7 cm³/s/2.85 cm²=2.46 cm/s.

With a permitted HZ piston amplitude of 0.125 cm, the volume in the HZ must be reduced after 0.125 cm/2.46 cm/s=50 ms.

The volume leaked through the leaking 3/2 valve in 50 ms is then 0.050s*7 cm³/s=0.35 cm³. By shutting off the 3/2 valve and opening the exhaust valve (not drawn), brake fluid flows from the master brake cylinder, HZ, through the 3/2 valve, to the brake circuit, BK, and through the exhaust valve (not drawn) from the brake circuit BK to the reservoir. With valve cross-sectional areas of the 3/2 valve of e.g. 0.8 mm² and of the outlet valve (not drawn) of e.g. 0.8 mm² and mean pressure in the master brake cylinder of e.g. e.g. 10 bar, the volume flow out of the master cylinder, HZ, at a valve constant of e.g. 8.24:8.24* 0.8*sqrt(10*0.64/(0.64+0.64))=8.24*0.8*sqrt(5)=14.7 cm³/s. The leakage volume of 0.35 cm³ then flows off through the 3/2 valve and the exhaust valve (not drawn) in 0.35 cm³/14.7 cm³/s=approx. 25 ms. One cycle then takes 2*(50+25)ms=150 ms. The pedal vibrates with a frequency of approx. 1000 ms/150 ms=approx. 6.7 Hz.

It goes without saying that the actuation system for a braking system according to the invention only forms a complete braking system together with wheel brakes and intermediate valve circuits, such as known ABS/ESP modules or individual switching valves upstream of each wheel brake, via which the pressure control takes place. This also requires a control and regulation unit, commonly referred to as an ECU. All these components are or can of course also be part of the braking system according to the invention.

### LIST OF REFERENCE SIGNS

1 Pedal
2 reservoir
3 Piston plunger
4 Magnet armature
4a Stop of solenoid armature 4
5 Exciter winding
6 Solenoid yoke
7, 7a Pin
7, 7a Pin
9 Solenoid housing
10 Heat sink
AN1, AN2, AN3 Valve connections
BE Assembly unit
BK1, BK2 first and second brake circuit
BP1, BP2 isolating valves
DZ Pressure supply device
F1, F2, F3 Filter
FP Force due to hydraulic pressure
H Stroke of solenoid armature
HV1 first hydraulic connection
HV2 second hydraulic connection
K1, K2, K3 valve chamber
Li Hydraulic lines
MV 3/2-way valve
PD Separating valve
R1, R2 working chambers of the master cylinder
RF Valve spring force
SHZ/THZ Single or tandem brake master cylinder
ST Plunger
V1, V2, V3 2/2-way switching valves
VF Valve spring
VS1 first valve seat
VS2 second valve seat
VSK1 first valve closing body
VSK2 second valve closing body
WS travel simulator

1. A hydraulic actuation system for a braking system, comprising:
at least one brake circuit having at least one hydraulically actuated wheel brake,
a master brake cylinder, enabled to be actuated by an actuating device in the form of a brake pedal, with at least one working chamber, and
a hydraulically acting travel simulator configured to generate a reaction force to the actuating device,
wherein the at least one working chamber is enabled to be connected via a controlled 3/2-way valve either to a brake circuit of the at least one brake circuit or to the travel simulator.

2. The hydraulic actuating system according to claim 1, further comprising at least one pressure-generating device arranged to perform pressure control or regulation, in the at least one brake circuit.

3. The hydraulic actuating system according to claim 2, wherein, in a normal mode of operation of the hydraulic actuating system or braking system, the pressure control or regulation in the at least one brake circuit takes place by means of the pressure-generating device and the at least one working chamber is hydraulically connected, via a hydraulic connection, only to the travel simulator via the 3/2-way valve.

4. The hydraulic actuating system according to claim 2, wherein the 3/2-way valve is arranged in the hydraulic connection between the pressure-generating device and the master brake cylinder.

5. The hydraulic actuating system according to claim 4, further comprising, in addition to the 3/2-way valve, at least one further switching valve arranged between the pressure supply device and the 3/2-way valve in the hydraulic connection between the pressure-generating device and the master brake cylinder.

6. The hydraulic actuating system according to claim 3, wherein, in a non-normal mode of operation in which there is a malfunction or in which a controlled pressure change in at least one wheel brake is no longer possible or ensured by means of one or no pressure supply device, the at least one working chamber is hydraulically connected via the 3/2-way valve to one or more brake circuits of the at least one brake circuit.

7. The hydraulic actuation system according to claim 1, further comprising at least one filter arranged to prevent dirt from entering the 3/2-way valve, wherein the at least one filter is provided for at least one hydraulic connection of the 3/2-way valve and is arranged in a housing of the 3/2-way valve.

8. The hydraulic actuation system according to claim 1, wherein the hydraulic actuation system or brake system includes a valve module for a plurality of valves, the 3/2-way valve being arranged in the valve module.

9. The hydraulic actuation system according to-claim 1. wherein the master brake cylinder has two working chambers, wherein each of the working chambers is connected to a respective one of the at least one brake circuit via a respective hydraulic line that is capable of being shut off by means of a valve, wherein one of the two valves is the 3/2-way valve.

10. A brake system including the hydraulic actuation system according to claim 1.

11. A 3/2-way valve configured for use in the hydraulic actuation system according to claim 1, the 3/2-way valve comprising two valve seats, each of which is enabled to be closed by a respective valve closing body, wherein a first valve closing body is connected to a solenoid armature and cooperates with a first valve seat of the two valve seats, and a second valve closing body cooperates with a second valve seat of the two valve seats, and further comprising a plunger which engages through both of the two valve seats and is also connected to the solenoid armature.

12. The 3/2-way valve according to claim 11, wherein the first valve closing body is arranged in a first valve chamber and the second valve closing body is arranged in a second valve chamber, the valve seats being annular with conical valve seat surfaces, a third valve chamber being arranged between the first and the second valve chambers, and wherein in a first position of the solenoid armature, which is achieved by energizing an excitation coil of the 3/2-way valve, the first valve closing body is sealingly pressed against the first valve seat, thereby closing a first hydraulic connection from the first valve chamber to the third valve chamber, wherein at the same time the plunger pushes the second valve closing body away from the second valve seat against a first valve spring in such a way that a second hydraulic connection is opened from the second valve chamber towards the third valve chamber.

13. The 3/2-way valve according to claim 11, wherein in a second position of the solenoid armature, which is achieved by not energizing the 3/2-way valve and the first valve spring, the first hydraulic connection is open and the second hydraulic connection is closed.

14. The 3/2-way valve according to claim 12, wherein a first connection of the 3/2-way valve arranged to connect to the at least one brake circuit is hydraulically connected to the first valve chamber, wherein a second connection of the 3/2-way valve arranged to connect the 3/2-way valve to the travel simulator is hydraulically connected to the second valve chamber, and wherein a third connection of the 3/2-way valve arranged to connect the 3/2-way valve to the master brake cylinder is hydraulically connected to the third valve chamber.

15. The 3/2-way valve according to claim 12, wherein the first valve spring determines an opening pressure of the second hydraulic connection, wherein the valve spring is arranged in the second valve chamber.

16. The 3/2-way valve according to claim 12, further comprising a second valve spring, which is arranged to act on the first valve closing body and/or the solenoid armature.

17. The 3/2-way valve according to claim 12, wherein a permanent magnet is arranged in a yoke of the solenoid armature in such a way that a magnetic field of the permanent magnet supports a spring force of the first valve spring for closing the second valve seat when the excitation coil is not energized.

18. The 3/2-way valve according to claim 11, wherein the first valve seat is arranged on a solenoid yoke of the solenoid armature or wherein a region of the solenoid yoke is formed as the first valve seat.

19. The 3/2-way valve according to claim 12, wherein the excitation coil is cast with a housing of the 3/2-way valve and/or wherein at least one heat sink or at least one heat exchanger unit is arranged on the housing of the 3/2-way valve.

20. The 3/2-way valve according to claim 12, wherein the structural unit forming the second valve chamber forms the second valve seat accommodates the first valve spring, the second valve closing body, and a spring plate.

21. The 3/2-way valve according to claim 14, wherein the second valve chamber is in hydraulic connection with the second connection of the 3/2-way valve via window-like passages in the spring plate or via window-like passages in a wall of a structural unit forming the second valve chamber.

22. The 3/2-way valve according to claim 12, wherein the excitation coil is cast with a solenoid housing.

23. A method of operating the 3/2-way valve according to claim 13, the method comprising reducing a control current after the solenoid armature has reached the second position.

24. A method of for operating the 3/2-way valve according to claim 11, the method comprising, in an event of failure of a first valve seat of the two valve seats, applying a pedal force using pressure generated by the pressure supply device and a corresponding actuation of the 3/2-way valve in order to simulate or generate a pedal reaction feeling.

25. The hydraulic actuating system according to claim 5, wherein the at least one further switching valve is arranged in a portion of the hydraulic connection that includes a hydraulic line connecting the pressure supply device to a brake circuit line.
